(19) United States
(12) Patent Application Publication
(10) Pub. No.: US 2009/0168037 A1
(43) Pub. Date: Jul. 2, 2009

(54) Lithographic apparatus and device manufacturing method

(75) Inventors: Roger Johannes Maria Hubertus Kroonen, Eindhoven (NL); Sebastiaan Maria Johannes Cornelissen, Eindhoven (NL); Sjoerd Nicolaas Lambertus Donders, Vught (NL); Nicolaas Ten Kate, Almkerk (NL); Ronald Van Der Ham, Maarheeze (NL); Niek Jacobus Johannes Roset, Eindhoven (NL); Fransiscus Mathijs Jacobs, Asten (NL); Michel Riepen, Veldhoven (NL); Gerardus Arnoldus Hendricus Fanciscus Janssen, Eindhoven (NL); Reinder Wietse Roos, Utrecht (NL); Mattijs Hogeland, Amsterdam (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/292,963

(22) Filed: Dec. 1, 2008

Related U.S. Application Data
(60) Provisional application No. 60/996,737, filed on Dec. 3, 2007.
(60) Provisional application No. 61/006,026, filed on Dec. 14, 2007.

(51) Int. Cl. G03B 27/60; G03B 27/52

(52) U.S. Cl. 355/67; 355/73

(57) ABSTRACT

An immersion lithographic projection apparatus is disclosed. The apparatus includes a substrate table for holding a substrate and a liquid supply system for supply liquid to the substrate. The apparatus is constructed and arranged to allow the liquid to flow off the substrate and over at least two edges of a top surface of the substrate table. The geometry of the edge may be optimized to reduce a static thickness of a layer of liquid on the top surface.

This application claims priority and benefit under 35 U.S.C. §119(e) to U.S. Provisional Patent Application Ser. No. 60/996,737, entitled “Lithographic Apparatus and Device Manufacturing Method”, filed on Dec. 3, 2007, and to U.S. Provisional Patent Application Ser. No. 61/006,026, entitled “Lithographic Apparatus and Device Manufacturing Method”, filed on Dec. 14, 2007. The contents of those applications are incorporated herein in their entirety by reference.

### FIELD

The present invention relates to a lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. The liquid may be distilled water, although other liquids can be used. An embodiment of the present invention will be described with reference to liquid. However, other fluids may be suitable, particularly a wetting fluid, an incompressible fluid and/or a fluid with higher refractive index than air, desirably a higher refractive index than water. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including liquid such as water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable are a hydrocarbon, a fluorohydrocarbon, or an aqueous solution. These are also included in an embodiment of the present invention.

However, submersing the substrate or substrate and substrate table in a bath of liquid (see, for example, U.S. Pat. No. 4,509,852, means that there is a large body of liquid that must be accelerated during a scanning exposure. This requires additional or more powerful motors and turbulence in the liquid may lead to undesirable and unpredictable effects.

One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet IN onto the substrate, preferably along the direction of movement of the substrate relative to the final element, and is removed by at least one outlet OUT after having passed under the projection system. That is, as the substrate is scanned beneath the element in a −X direction, liquid is supplied at the +X side of the element and taken up at the −X side. FIG. 2 shows the arrangement schematically in which liquid is supplied via inlet IN and is taken up on the other side of the element by outlet OUT which is connected to a low pressure source. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element.

An immersion lithography solution with a localized liquid supply system is shown in FIG. 4. Liquid is supplied by two groove inlets IN on either side of the projection system PL and is removed by a plurality of discrete outlets OUT arranged radially outwardly of the inlets IN. The inlets IN and outlets OUT can be arranged in a plate with a hole in its center and through which the projection is project. Liquid is supplied by one groove inlet IN on one side of the projection system PS and removed by a plurality of discrete outlets OUT on the other side of the projection system PL. This causes a flow of a thin film of liquid between the projection system PS and the substrate W. The choice of which combination of inlet IN and outlets OUT to use can depend on the direction of movement of the substrate W (the other combination of inlet IN and outlets OUT being inactive).

In European Patent Application Publication No. 1420300 and United States Patent Application Publication No. 2004-0136494, each of which is hereby incorporated in its entirety by reference, the idea of a twin or dual stage immersion lithography apparatus is disclosed. Such an apparatus is provided with two tables for supporting the substrate. Leveling measurements are carried out with a table at a first position, without immersion liquid. Exposure is carried out with a table at a second position, where immersion liquid is present. Alternatively, the apparatus may have only one table movable between exposure and measurement positions.

PCT patent application publication no. WO 2005/064405 discloses an all wet arrangement. In such a system the whole top surface of the substrate is covered in liquid. A liquid supply system provides liquid to the gap between the final element of the projection system and the substrate. That liquid is allowed to leak over the remainder of the substrate. A barrier at the edge of a substrate table prevents the liquid from escaping so that it can be removed from the top surface of the substrate table in a controlled way.

### SUMMARY

It is desirable, for example, to provide a system for removing liquid from the top surface of a substrate table in immersion lithography.

According to an aspect of the invention, there is provided an immersion lithographic projection apparatus comprising a substrate table for holding a substrate, and a liquid supply system for supplying a liquid to the substrate, wherein the apparatus is constructed and arranged to allow the liquid to flow off the substrate and over at least two outer edges of a top surface of the substrate table.

In an embodiment, the apparatus further comprises an electrode in or on each of the edges and a controller configured to apply a potential difference between the electrode and another electrode to establish an electro-wetting effect. The apparatus may comprise a plurality of electrodes in or on each of the edges and wherein the another electrode is at least one of the plurality of electrodes. In an embodiment, the liquid supply system is configured to cover the substrate with liquid.

According to an aspect of the invention, there is provided an immersion lithographic projection apparatus, comprising a substrate table for holding a substrate, wherein an edge of the substrate table has a portion with an edge radius of greater than 5 mm.

In an embodiment, the edge radius decreases with angular displacement of the edge surface from the vertical. The edge radius may vary between at least 7 and 8 mm, between 6 and 9 mm, or between 5 and 10 mm. In an embodiment, the portion of the edge has an edge radius of greater than 6 mm, greater than 7 mm or greater than 8 mm.

According to an aspect of the invention, there is provided an immersion lithographic projection apparatus, comprising a substrate table for holding a substrate, the substrate table being configured to have a liquid flow flow off the substrate and over an edge region of the substrate table, the edge region having a radius of curvature which decreases with displacement away from the substrate in the direction of the liquid flow over the edge region.

According to an aspect of the invention, there is provided an immersion lithographic projection apparatus comprising a substrate table for holding a substrate, wherein an edge of the substrate table over which, in use, liquid flows has a portion furthest from a top surface which has an angle of between 80 and 100° to horizontal.

In an embodiment, the portion is elongate in a downward direction. The portion may be a plurality of portions which are spaced apart. The portions may be spaced apart equidistantly. The portions may be spaced apart by a distance selected such that substantially the whole of a top surface of the substrate table and/or the edge face is maintained wetted.

According to an aspect of the invention, there is provided an immersion lithographic projection apparatus comprising: a substrate table for holding a substrate, wherein the substrate table is configured to have a liquid flow flow off the substrate and over an edge of the substrate table, the edge having a plurality of downwardly directed protrusions configured to direct the liquid flow.

According to an aspect of the invention, there is provided a method of controlling a flow of liquid in an immersion lithographic apparatus, the method comprising supplying a liquid to a substrate table or a substrate held by the substrate table so that the liquid flows off the substrate and directing the liquid as it flows over an edge of the substrate table by a plurality of downwardly directed protrusions located on the edge.

According to an aspect of the invention, there is provided a device manufacturing method comprising projecting a patterned beam of radiation through an immersion fluid onto a substrate and allowing the immersion fluid to flow off the substrate and over at least two outer edges of a top surface of a substrate table on which the substrate is held.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts another liquid supply system for use in a lithographic projection apparatus;

FIG. 5 depicts, in cross-section, a barrier member acting as a liquid supply and removal system which may be used in an embodiment of the present invention as a liquid supply system;

FIG. 6 illustrates, in cross-section, a liquid supply system and a liquid removal system in accordance with an embodiment of the present invention;

FIG. 7 illustrates, in plan, the substrate table and liquid removal system of FIG. 6;

FIGS. 8 and 10 illustrate, in cross-section, in detail, edge portions of the substrate table over which, in use, liquid flows; and

FIG. 9 is a graph showing experimental liquid thicknesses for various edge radiuses and flow rates.

### DETAILED DESCRIPTION

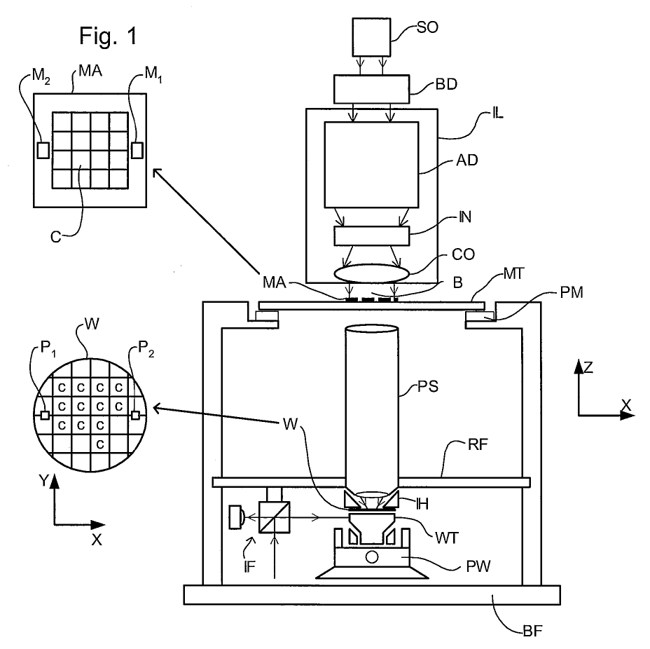

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies. The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Traditional arrangements for providing liquid between a final element of the projection system PS and the substrate can be classed into two general categories. These are the bath type arrangement in which the whole of the substrate W and optionally part of the substrate table WT is submerged in a bath of liquid and the so called localized immersion system which uses a liquid supply system in which liquid is only provided to a localized area of the substrate. In the latter category, the space filled by liquid is smaller in plan than the top surface of the substrate and the area filled with liquid remains stationary relative to the projection system PS while the substrate W moves relative to that area.

A further arrangement, to which an embodiment of the present invention is mainly directed, is the all wet solution in which the liquid is unconfined. In this arrangement the whole top surface of the substrate and all or part of the substrate table is covered in immersion liquid. This may be advantageous because then the whole top surface of the substrate is exposed to the same conditions. This has an advantage for temperature control and processing of the substrate. Also any contamination in the immersion liquid may be flushed away.

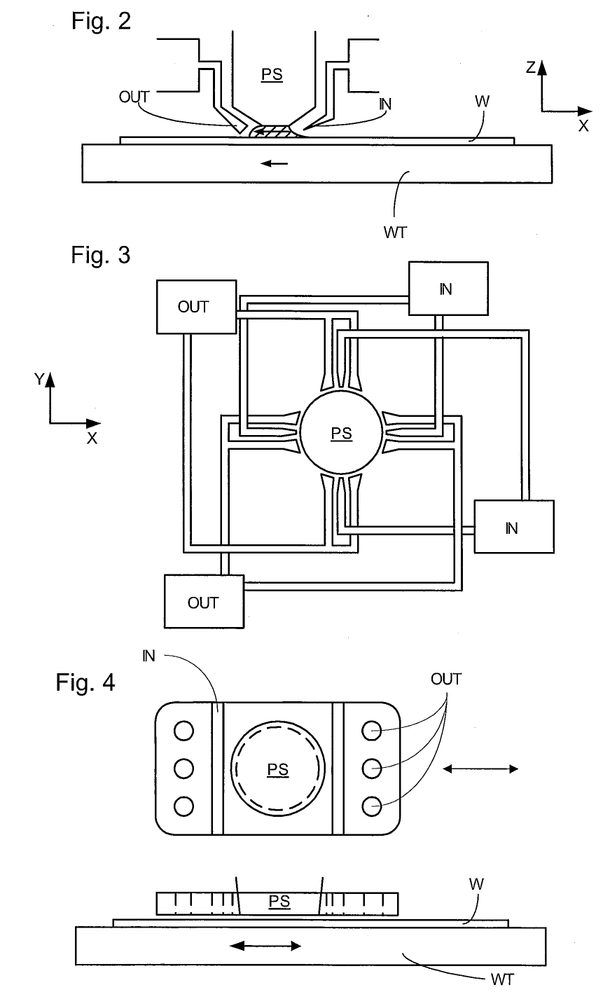

Any of the liquid supply devices of FIGS. 2-5 can also be used in such an all wet system; however, their sealing features are not present, are not activated, are not as efficient as normal or are otherwise ineffective to seal liquid to only the localized area. Four different types of localized liquid supply systems are illustrated in FIGS. 2-5. The liquid supply systems disclosed in FIGS. 2-4 were described above.

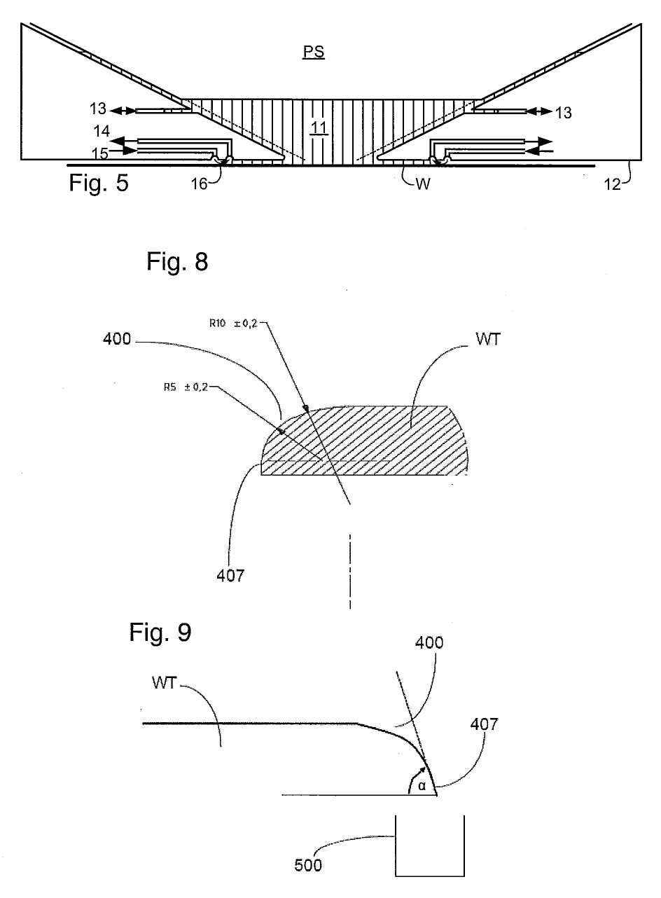

FIG. 5 schematically depicts a localized liquid supply system with a barrier member 12, which extends along at least a part of a boundary of the space between the final element of the projection system and the substrate table. The barrier member 12 is substantially stationary relative to the projection system in the XY plane though there may be some relative movement in the Z direction (in the direction of the optical axis). In an embodiment, a seal is formed between the barrier member and the surface of the substrate and may be a contactless seal such as a gas seal or fluid seal.

The barrier member 12 at least partly contains liquid in the space 11 between a final element of the projection system PL and the substrate W. A contactless seal 16 to the substrate may be formed around the image field of the projection system so that liquid is confined within the space between the substrate surface and the final element of the projection system. The space is at least partly formed by the barrier member 12 positioned below and surrounding the final element of the projection system PL. Liquid is brought into the space below the projection system and within the barrier member 12 by liquid inlet 13 and may be removed by liquid outlet 13. The barrier member 12 may extend a little above the final element of the projection system and the liquid level rises above the final element so that a buffer of liquid is provided. The barrier member 12 has an inner periphery that at the upper end, in an embodiment, closely conforms to the shape of the projection system or the final element thereof and may, e.g., be round. At the bottom, the inner periphery closely conforms to the shape of the image field, e.g., rectangular though this need not be the case.

The liquid is contained in the space 11 by a gas seal 16 which, during use, is formed between the bottom of the barrier member 12 and the surface of the substrate W. The gas seal is formed by gas, e.g. air or synthetic air but, in an embodiment, N₂ or another inert gas, provided under pressure via inlet 15 to the gap between barrier member 12 and substrate and extracted via outlet 14. The overpressure on the gas inlet 15, vacuum level on the outlet 14 and geometry of the gap are arranged so that there is a high-velocity gas flow 16 inwards that confines the liquid. The force of the gas on the liquid between the barrier member 12 and the substrate W contains the liquid in a space 11. Those inlets/outlets may be annular grooves which surround the space 11. The annular grooves may be continuous or discontinuous. The flow of gas 16 is effective to contain the liquid in the space 11. Such a system is disclosed in United States patent application publication no. US 2004-0207824.

Other arrangements are possible and, as will be clear from the description below, an embodiment of the present invention may use any type of localized liquid supply system as the liquid supply system.

One or more localized liquid supply systems seal between a part of the liquid supply system and a substrate W. Relative movement of that part of the liquid supply system and/or the substrate W may lead to breakdown of the seal and thereby leaking of liquid.

A difficulty with any of the localized area liquid supply systems is that it is difficult to contain all of the immersion liquid and to avoid leaving some behind on the substrate as the substrate moves relative to the projection system. In order to avoid liquid loss, the speed at which the substrate moves relative to the liquid supply system should be limited. This is particularly so with an immersion liquid capable of generating a high value of NA in the immersion lithography apparatus, especially a liquid other than water. Such a liquid tends to have a lower surface tension than water as well as a higher viscosity. Breakdown speed of a meniscus scales with surface tension over viscosity so that a high NA liquid may be far harder to contain. Leaving liquid behind on the substrate in only certain areas may lead to temperature variation of the substrate due to evaporation of the immersion liquid left behind on only certain areas of the substrate and thus possibly leading to overlay error.

Also or alternatively, as the immersion liquid evaporates, it is possible that drying stains (from contamination or particles) can be left behind on the substrate W after evaporation. Also or alternatively, the liquid may diffuse into the resist on the substrate leading to inconsistency in the photochemistry of the top surface of the substrate. Although a bath type solution (i.e. where the substrate is submerged in a container of liquid) would alleviate many of these problems, substrate swap in an immersion apparatus may be particularly difficult with a bath type solution. An embodiment of the present invention addresses one or more of these or other issues as will be described below.

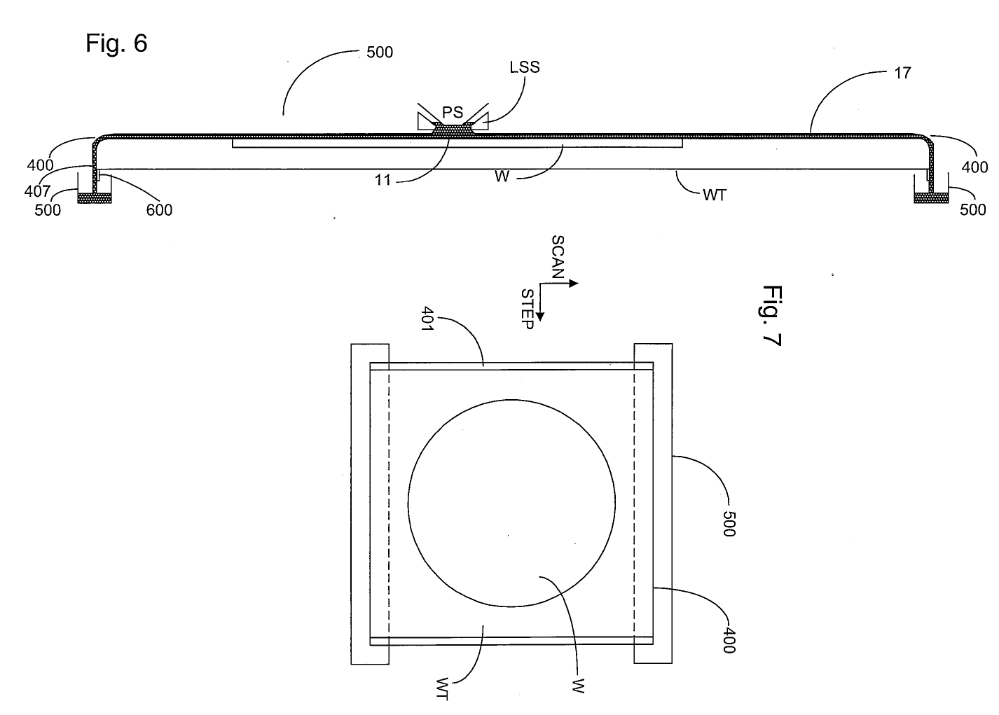

In an embodiment of the present invention, a localized liquid supply system LSS is used to provide liquid below the projection system PS above the substrate W. A flow of liquid in that area is generated. For this purpose any localized liquid supply system may be used, e.g. any one of the types shown in FIGS. 2-5, such as that illustrated in FIG. 5 or a variant thereof. However, the seal formed between the localized liquid supply system LSS and the substrate W does not need to be made to be particularly well and may in fact be entirely missing. That is, the liquid is unconfined by the liquid supply system. For example, all of the components on the bottom side of the barrier member 12 may be missing from the FIG. 5 embodiment. However, the type of seal or indeed complete absence of a seal is not critical to an embodiment of the present invention. The design is chosen such that a film or layer of liquid 17 covers substantially the whole of the top surface of the substrate W as is illustrated in FIG. 6. The top surface of the substrate table WT may be fully or partially covered in the layer of liquid 17. U.S. patent application publication no. US 2008-0073602 discloses several other embodiments which allow the whole of the top surface of the substrate W to be covered in a film of liquid 17. It will be understood that an embodiment of the present invention can be applied to all of the liquid supply systems disclosed in U.S. patent application publication no. US 2008-0073602.

In an embodiment of the present invention, liquid is allowed to drain off at least two edges 400 of the substrate table WT. The edges are edges of the top surface. The edges have an edge face 407. The edges are opposite edges of the substrate table WT. The edges are outer or outer most edges of the (top surface of the) substrate table WT. In an embodiment, the edges 400 are edges of the substrate table which are substantially perpendicular to the scan movement. This is the direction which has the longest stroke (i.e. is the long stroke direction) as well as the fastest acceleration. During the stroke the liquid is allowed to drain off along at least half or the whole length of the edge of the substrate table WT, not just at a small portion of the edge. Optionally no barrier to the flow of liquid off the substrate table (and/or barrier attached to the top surface of the substrate table WT) is provided radially outwardly of the edges over which the liquid flows.

As illustrated in FIG. 7, a barrier 401 may be provided along the edges substantially parallel to the scan direction. This barrier protrudes from the top surface of the substrate table WT to prevent liquid from falling off those edges. However, this is not necessarily the case and it can be arranged for liquid to drain off all edges of the top surface of the substrate table WT.

The liquid drains off the edges 400 and is caught by at least one gutter 500 before being removed. The gutter 500 can be mechanically dynamically decoupled from the substrate table WT or at least from the part which holds the substrate W. The gutter 500 may be attached to the long stroke positioning mechanism or may be independent of the long stroke positioning mechanism. The relative positions of the part which holds the substrate or substrate table WT and the gutter 500 may be fixed or there may be relative movement. In an embodiment, the gutter 500 has its own independent positioner, but this is not necessarily the case. A controller may be provided to move the gutter 500 such that its position is substantially constant relative to the edges 400. The gutter 500 may be moved independently of the substrate table WT. The independent movement may be in a direction substantially perpendicular to the elongate direction of the edge.

FIG. 6 shows, in a cross-section taken in a plane parallel to the scan direction, the arrangement of the present invention. As can be seen, liquid is allowed to flow off edges 400 which are substantially perpendicular to the scan direction. The liquid drains off the edge and falls into a gutter 500 positioned under the edge. Both the edge 400 and gutter 500 of FIG. 6 are elongate extending in and out of the paper. This can be seen more clearly in FIG. 7 which is a plan view of the substrate table and gutter 500 arrangement.

As can be seen in FIG. 6, liquid is provided to an area between the projection system and the substrate W. Liquid is allowed to leak under the liquid supply system LSS over the whole of the top surface of the substrate W. Furthermore, the liquid then flows or leaks onto the top surface of the substrate table WT. Thereafter the liquid flows or leaks over the edges 400 down at least part of the face 407 of the edge (i.e. the surface substantially perpendicular to the top surface) into the gutter 500. The liquid is removed from the gutter 500 thereafter.

The geometry of the edge 400 of the substrate table WT may be important to ensure that a good flow rate of liquid off the substrate table WT is possible without the film of liquid on the top of the substrate and substrate table WT breaking up.

When the substrate table is stationary, the thickness of the liquid layer 17 covering the substrate W and top surface of the substrate table WT increases. Once a certain thickness is reached, which is dependent at least partly upon the geometry of the edge 400, liquid will flow over the edge 400 off the substrate table WT. When the substrate table WT then first moves, this thick layer of immersion liquid 17 will flow over the edge 400 into the gutter 500. The layer of liquid 17 then decreases in thickness. If the static thickness of immersion liquid on the top surface of the substrate W and substrate table WT is too large, then after a stationary period the amount of liquid which flows into the gutter 500 can be difficult to accommodate and the gutter 500 may overflow. Therefore it is desirable to provide the edge geometry such that the static immersion liquid layer thickness on the substrate table WT is reduced or minimized. The liquid has a thickness because as the liquid flows over the edge surface, gravity accelerates the liquid to thin the immersion liquid film 17. Gravity and surface tension of the immersion liquid enable the liquid to hold to the surface of the edge. This is partly due to capillary pressure decreasing with radius. Thus a substrate table WT arranged to have an edge with decreasing radius with distance from the center of the top surface of the substrate table WT, enables a quantity of liquid smoothly to collapse into the gutter 500 with each successive stroke of the substrate table. Also the length of the edge over which liquid flows may be reduced—if a higher flow is needed, this could be achieved by increasing the length of the edge over which liquid drains. In an embodiment, liquid can flow off the whole length of the edge.

The radius of curvature of the part of the edge 400 closest the center of the top surface of the substrate table WT is significant. FIG. 8 shows a detail of the edge 400 in cross-section. As can be seen, the radius of the part of the edge 400 closest to the center of the top surface of the substrate table WT (or put another way, that part which is closest in angular displacement from the horizontal) has a radius of 10 mm. Further from the center of the top surface of the substrate table WT the radius can be decreased. The radius closest to the center of the top surface of the substrate table WT may determine the thickness of immersion liquid on a stationary substrate table WT. So the initial radius may be selected to optimize a liquid film on the substrate table WT to have a desired thickness.

FIG. 9 shows experimental results of the thickness of the layer of immersion liquid 17 on a stationary substrate table WT with an edge length of 240 mm. Four of the results are for an edge radius of 10 mm at four different flow rates and the other four are for the edge radius of 5 mm at four different flow rates. Each line is labeled first with the radius (labeled with R) and then the flow rate in liters per minute. What these results show is that for a given flow rate an edge having a higher radius will result in a lower thickness of immersion liquid when the substrate table WT is stationary. In practice other flow rates can be used. The larger the radius, the lower the resistance and the more time gravity acts to thin the layer and force the liquid to stick to the surface. A radius of 10 mm may be sufficient for a substrate table WT speed of up to 5 m/s. It is desirable to have a layer of immersion liquid on the substrate table as thin as possible, without the surface of the substrate table de-wetting.

Based on these experimental results, the substrate table edge 400 has a radius of greater than 5 mm, or at least 6, 7, 8 or 9 mm. In an embodiment, the edge 400 has a radius greater than 10 mm. If too large an edge radius is chosen, this will take up more space in the apparatus and is therefore undesirable.

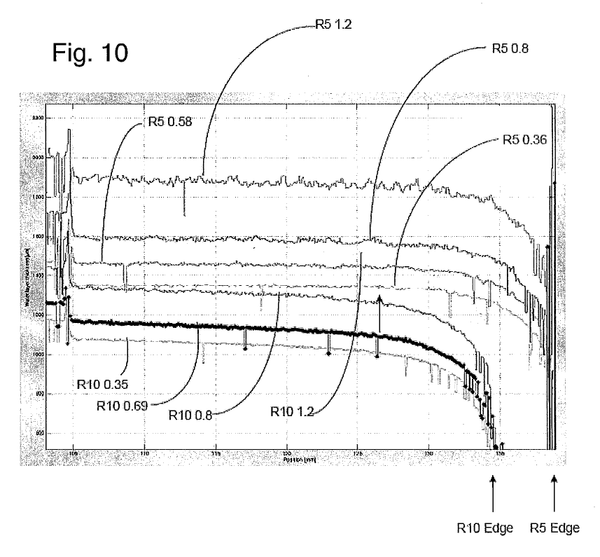

In order to obtain the advantage of a large radius edge without taking up the corresponding space, it is possible to provide the edge with a large radius close to the center of the top surface of the substrate table WT and then to reduce the radius of the edge further from the center of the top surface of the substrate table WT. Put another way, the edge radius increases with angular displacement of the edge surface from the vertical. Thus, as is illustrated in FIG. 8, the edge 400 is first radiused at 10 mm and then later at 5 mm. The very bottom of the edge is illustrated as being vertical and straight (i.e. a radius of infinity). This aspect will be described in more detail with reference to FIG. 10.

If there is a change in radius of the edge 400, desirably the transition between two radiuses is a smooth transition. FIG. 8 illustrates a situation where the radius of curvature of the edge varies between 5 and 10 mm. However, a similar advantage may be achieved by varying the radius between other limits such as 6 and 9 mm or 8 and 10 mm and even between 7 and 8 mm.

These measures have an advantage of decreasing the amount of immersion liquid which can be held on a top surface of a stationary substrate table WT. Thus, the buffer volume required of the gutter 500 may be reduced. An added bonus is that this may reduce the load on the gutter and thus the load on an actuator which moves the gutter, if such is present.

Varying the radius from a big to a small radius may achieve a small substrate table height. Further, the risk of the immersion liquid detaching during scanning may reduced. Further, the risk of the immersion liquid detaching from the edge prior to falling into the gutter 500 may decrease. Because the gutter 500 may be smaller and will hold less immersion liquid, turbulence within the gutter may be reduced. Finally, because a higher flow rate of immersion liquid can be used for a given radius, this may improve the thermal stability of the substrate W and substrate table WT, and thus may lead to better imaging accuracy and/or a reduction in overlay error.

Put another way, the change of radius of curvature enables a smooth flow of liquid into the gutter as it flows over the edge of the substrate table. The flow is gravity assisted. That is, as the liquid flows over the edge it accelerates downwards under its own weight. The increasing radius of curvature accommodates the increasing vertical speed of the liquid as it passes over the edge. As the liquid accelerates downwards, owing to surface tension, the liquid pulls on the liquid behind it in the liquid flow. At the same time, the surface tension pulls back on the liquid at the front of the liquid flow. The surface tension causes the liquid film to thin (i.e. reduce in thickness) as it moves over the curved edge; and it is still sufficient to keep the surface of the liquid film stable after the liquid has left the curved surface. In this way, during scanning, the risks of de-wetting, and of the liquid detaching from the substrate table surface, are each reduced, and desirably minimized. The changing radius of curvature facilitates the smooth transfer of the liquid from the substrate table to the gutter.

With the stroke motion of the substrate table, the flow of liquid fluctuates from a minimum quantity of liquid moving with a minimum flow rate, to a maximum quantity of liquid at peak flow. In an embodiment the variable flow is managed by controlling the movement of the substrate table WT. The movement may be managed, for example, to help ensure that the liquid flow into the gutter is smooth so that at peak flow a quantity of immersion liquid may smoothly “collapse” into the gutter 500 and be smoothly extracted. If this acceleration is not managed successfully the liquid flow may form into droplets which may splash.

It is desirable that all of the edge 400 i.e. including the face or the vertical portions of the edge 407, remain covered in the liquid at all times. If any portion of the edge 400 de-wets, the liquid falling over the edge 400 can have a tendency to detach from the edge 400 and thereby either miss the gutter 500 or splash into the gutter 500. Either of those situations is desirably avoided so as to prevent contamination of parts of the apparatus with immersion liquid. De-wetting of the edge is typically caused by flow over the edge breaking up into droplets, particularly during a scanning acceleration (e.g., during the long stroke and short stroke movements). The angle of the face 407 of the edge 400 furthest from the top surface of the substrate table WT is significant in this regard.

FIG. 10 shows the angle α which is relevant. Thus, the angle of interest is the angle α which is the angle from the horizontal which the surface of a portion of the face 407 of the edge 400 furthest from the top surface makes. A suitable range for angle α is 80-100°. In an embodiment, the angle is between 85-95° and 90° appears most effective at maintaining the whole edge 400 wet.

Maintaining the edge 400 wet has an advantage that the gutter 500 may be smaller because it doesn't not need to be made larger (i.e. it can be thinner) to catch any potential splashes. Also the gutter 500 may then be positioned under the edge of the substrate table WT keeping the effective foot print of the substrate table WT low. Further, preventing de-wetting may result in better reproducibility of forces on the substrate table WT and thus offer better control of the substrate table WT. Finally, if the whole of the edge remains wet, the thermal stability of the substrate table WT may be improved. In an embodiment, to maximize flow off the substrate table, the whole edge of the substrate table is used for the flow of liquid off the substrate table. That is, good flow management of the immersion liquid in its transition from the substrate table into the gutter is desirable. To achieve this, the full length of the substrate table edge is used.

Extending the edge 400 downwards by providing a lip 600 (see FIG. 6) may be advantageous. This is at least partly because a side wall of the gutter 500 can then be made to extend higher than the bottom of the edge to reduce the likelihood of liquid escaping. The lip 600 may not be integral to the substrate table WT. It is desirable to avoid liquid from creeping under the substrate table WT and making a component of the substrate table WT wet. For this purpose, the inner surface of the lip 600 can be made liquidphobic. The inner surface is that surface closest to the center of the substrate table WT. If the outer surface of the lip (i.e. the right hand side as illustrated in FIG. 9) is made liquidphilic, this reduces the chance of the film breaking up on the edge 400. Indeed, the other parts of the edge 400 could advantageously be made liquidphilic. Furthermore, if the edge of the lip 600 or bottom of edge 400 is made sharp (for example with a radius of less than 1 mm or 0.5 mm or 0.1 mm), this may also reduce the chance of liquid creeping under the edge 400. If no lip 600 is present, these features may be provided on the substrate table bottom edge corner.

The lip 600 is elongate in the vertical direction (as well as in the same direction as the gutter 500 and edge 400 are elongate). The lip 600 may be resiliently deformable or may break off easily so as to avoid damage in the event of it coming in contact with another part of the apparatus.

De-wetting may be caused by bad pinning of the meniscus of the film of immersion liquid. Bad pinning would mean that the meniscus is not pinned to a certain part of substrate table edge in the elongate direction. Relative to the rest of the edge (where the pinning is good) the flow of the immersion fluid is uneven. De-wetting may allow contaminants to collect on the surface of the substrate table, especially at or near the de-wetted portions. The deposited contaminants may disrupt the smooth flowing of the liquid, and thus the surface tension of the immersion liquid film. More de-wetting may be consequentially caused. De-wetting may prevent a smooth flow of the immersion liquid.

In order to address the issue of maintaining an edge of the substrate table wet, further measures may be taken. One further measure is to have the surface of the edge have a property such that the surface is liquidphilic to the immersion liquid. Additionally or alternatively, the lip 600 may have a plurality of lips along the elongate direction of the edge. At the edges of each lip the liquid will be pinned. Both of these measures are described in more detail below.

An electrode may be embedded or provided on the surface of the edge 400. The principle of electro-wetting can then be used to make the surface liquidphilic to the immersion liquid. For example, electrodes may be placed in a series in which every other electrode is insulated from the surface and the other electrodes are on the surface such that liquid contacts them. Then, by applying a voltage difference between the exposed electrodes, and therefore the liquid, and the non-exposed electrodes, the liquid in contact with one of the exposed electrodes will undergo an electro-wetting effect on the insulated surface of the electrode. Accordingly, the contact angle of the immersion liquid to the face of the edge is reduced. Thus, a film is less likely to break up into droplets. If the film does break up into droplets, the droplets are more likely to spread out and form a film again. U.S. patent application No. US 60/996,740, titled “LITHOGRAPHIC APPARATUS AND DEVICE MANUFACTURING METHOD” filed Dec. 3, 2007 discusses this and other subjects in detail. Any of the techniques disclosed in that application may be used to arrange for an electro-wetting effect on the edge of the substrate table. The electrodes may be in any pattern, for example as horizontal or vertical stripes or even in a grid-like pattern.

The lip 600 may be a continuous rim or discontinuous, for example as one or more lips, which may be arranged in a repeating series. Having a series of lips 600 around the edge 400 may enhance the de-wetting resistance. Each lip 600 has a sharp point/edge which pins the surface or meniscus of the liquid. As the surface of the liquid is smooth, surface tension of the liquid ensures liquid is pulled thinly across the surface of the substrate table WT, so that more of the surface of the substrate table WT is covered than normal. Spacing a series of these lips 600 along the edge 400 may help ensure that a lot more of the surface of the substrate table WT is covered. Optimizing the distance between lips 600 ensures that the entire surface of the substrate table WT does not de-wet.

In an aspect, there is provided an immersion lithographic projection apparatus comprising a substrate table configured to hold a substrate, and a liquid supply system configured to supply liquid to the substrate, wherein the apparatus is constructed and arranged to allow the liquid to flow off the substrate and over at least two outer edges of a top surface of the substrate table. Optionally, the apparatus further comprises a gutter configured to collect liquid flowing over the edges. Desirably, the gutter is mechanically dynamically decoupled from the top surface. Optionally, the edges are perpendicular to a scan direction of the apparatus. Optionally, the liquid flows at least partly down a face of each of the edges before detaching from the edge. Optionally, the apparatus further comprises an electrode in or on each of the edges and a controller configured to apply a potential difference between the electrode and another electrode to establish an electro-wetting effect. Desirably, the apparatus comprises a plurality of electrodes in or on each of the edges and wherein the another electrode is at least one of the plurality of electrodes. Optionally, the liquid supply system is configured to cover the substrate with liquid.

In an aspect, there is provided an immersion lithographic projection apparatus, comprising a substrate table configured to hold a substrate, wherein a top edge of the substrate table has a portion with an edge radius of greater than 5 mm. Optionally, the edge radius decreases with angular displacement of the edge surface from the vertical. Desirably, the edge radius varies between at least 7 and 8 mm, between 6 and 9 mm, or between 5 and 10 mm. Optionally, the portion of the edge has an edge radius of greater than 6 mm, greater than 7 mm or greater than 8 mm.

In an aspect, there is provided an immersion lithographic projection apparatus, comprising a substrate table configured to hold a substrate, the substrate table being configured to have a liquid flow flow off the substrate and over an edge region of the substrate table, the edge region having a radius of curvature which decreases with displacement away from the substrate in the direction of the liquid flow over the edge region. Optionally, the radius changes smoothly.

In an aspect, there is provided an immersion lithographic projection apparatus comprising a substrate table configured to hold a substrate, wherein an edge face of the substrate table over which, in use, liquid flows has a portion furthest from a top surface of the substrate table which has an angle of between 80 and 100° to the horizontal. Optionally, the angle is between 85 and 95° to the horizontal. Optionally, the portion has a bottom edge which has a radius of less than 1 mm, or less than 0.5 mm, or less than 0.1 mm. Optionally, the portion, on an inner surface, is liquidphobic to the liquid. Optionally, the portion is resiliently deflectable. Optionally, the portion is elongate in the vertical direction. Optionally, the portion is not integral with a top surface of the substrate table. Optionally, the portion is elongate in a downward direction. Desirably, the portion is a plurality of portions which are spaced apart. Desirably, the portions are spaced apart equidistantly. Desirably, the portions are spaced apart by a distance selected such that substantially the whole of a top surface of the substrate table and/or the edge face is maintained wetted.

In an aspect, there is provided an immersion lithographic projection apparatus comprising a substrate table configured to hold a substrate, wherein the substrate table is configured to have a liquid flow flow off the substrate and over an edge of the substrate table, the edge having a plurality of downwardly directed protrusions configured to direct the liquid flow.

In an aspect, there is provided a method of controlling a flow of liquid in an immersion lithographic apparatus, the method comprising supplying a liquid to a substrate table or a substrate held by the substrate table so that the liquid flows off the substrate, and directing the liquid as it flows over an edge of the substrate table by a plurality of downwardly directed protrusions located on the edge.

In an aspect, there is provided a device manufacturing method comprising projecting a patterned beam of radiation through an immersion fluid onto a substrate, and allowing the immersion fluid to flow off the substrate and over at least two outer edges of a top surface of a substrate table on which the substrate is held.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

While specific embodiments of the invention have been described above, it will be appreciated that the invention may be practiced otherwise than as described. For example, the invention may take the form of one or more computer programs containing one or more sequences of machine-readable instructions describing a method as disclosed above, or one or more data storage medium (e.g. semiconductor memory, magnetic or optical disk) having such one or more computer program stored therein. The one or more different controllers referred to herein may be operable when the one or more computer programs are read by one or more computer processors located within at least one component of the lithographic apparatus. One or more processors are configured to communicate with the at least one of the controllers; thereby the controller(s) operate according the machine readable instructions of one or more computer programs.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion fluid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. An immersion lithographic projection apparatus comprising:
a substrate table configured to hold a substrate; and
a liquid supply system configured to supply liquid to the substrate, wherein the apparatus is constructed and arranged to allow the liquid to flow off the substrate and over at least two outer edges of a top surface of the substrate table.

2. The apparatus of claim 1, further comprising a gutter configured to collect liquid flowing over the edges.

3. The apparatus of claim 2, wherein the gutter is mechanically dynamically decoupled from the top surface.

4. The apparatus of claim 1, wherein the edges are perpendicular to a scan direction of the apparatus.

5. The apparatus of claim 1, wherein the liquid flows at least partly down a face of each of the edges before detaching from the edge.

6. The apparatus of claim 1, further comprising an electrode in or on each of the edges and a controller configured to apply a potential difference between the electrode and another electrode to establish an electro-wetting effect.

7. An immersion lithographic projection apparatus, comprising a substrate table configured to hold a substrate, wherein a top edge of the substrate table has a portion with an edge radius of greater than 5 mm.

8. The apparatus of claim 7, wherein the edge radius decreases with angular displacement of the edge surface from the vertical.

9. An immersion lithographic projection apparatus, comprising a substrate table configured to hold a substrate, the substrate table being configured to have a liquid flow flow off the substrate and over an edge region of the substrate table, the edge region having a radius of curvature which decreases with displacement away from the substrate in the direction of the liquid flow over the edge region.

10. The apparatus of claim 9, wherein the radius changes smoothly.

11. An immersion lithographic projection apparatus comprising a substrate table configured to hold a substrate, wherein an edge face of the substrate table over which, in use, liquid flows has a portion furthest from a top surface of the substrate table which has an angle of between 80 and 100 °to the horizontal.

12. The apparatus of claim 11, wherein the angle is between 85 and 95° to the horizontal.

13. The apparatus of claim 11, wherein the portion has a bottom edge which has a radius of less than 1 mm, or less than 0.5 mm, or less than 0.1 mm.

14. The apparatus of claim 11, wherein the portion, on an inner surface, is liquidphobic to the liquid.

15. The apparatus of claim 11, wherein the portion is resiliently deflectable.

16. The apparatus of claim 11, wherein the portion is elongate in the vertical direction.

17. The apparatus of claim 11, wherein the portion is not integral with a top surface of the substrate table.

18. An immersion lithographic projection apparatus comprising a substrate table configured to hold a substrate, wherein the substrate table is configured to have a liquid flow flow off the substrate and over an edge of the substrate table, the edge having a plurality of downwardly directed protrusions configured to direct the liquid flow.

19. A method of controlling a flow of liquid in an immersion lithographic apparatus, the method comprising:
supplying a liquid to a substrate table or a substrate held by the substrate table so that the liquid flows off the substrate; and
directing the liquid as it flows over an edge of the substrate table by a plurality of downwardly directed protrusions located on the edge.

20. A device manufacturing method comprising:
projecting a patterned beam of radiation through an immersion fluid onto a substrate; and
allowing the immersion fluid to flow off the substrate and over at least two outer edges of a top surface of a substrate table on which the substrate is held.
